(19) United States
(12) Patent Application Publication
(10) Pub. No.: US 2017/0046298 A1
(43) Pub. Date: Feb. 16, 2017

(54) ASYNCHRONOUS FIRST-IN FIRST-OUT BUFFER APPARATUS WITH ACTIVE RATE CONTROL AND DYNAMIC RATE COMPENSATION AND ASSOCIATED NETWORK DEVICE USING THE SAME

(71) Applicant: MEDIATEK INC., Hsin-chu (TW)

(72) Inventors: Ching-Hao Yu, Yilan County (TW); Chi-Yung Wang, Hsinchu City (TW); Hsuan-Hung Chen, Taipei City (TW)

(21) Appl. No.: 15/199,914

(22) Filed: Jun. 30, 2016

Related U.S. Application Data
(60) Provisional application No. 62/203,399, filed on Aug. 11, 2015.

(51) Int. Cl. G06F 13/42; G06F 13/16

(52) U.S. Cl. CPC G06F 13/4226; G06F 13/1673

(57) ABSTRACT

An asynchronous first-in first-out (AFIFO) buffer apparatus has an AFIFO buffer and a rate control circuit. The AFIFO buffer receives a data input from a first processing circuit operating under a first clock, and transmits a data output to a second processing circuit operating under a second clock, where the first clock is asynchronous to the second clock. The rate control circuit actively controls a data transfer rate of the data input regardless of a water level of the AFIFO buffer, and further adaptively applies compensation to the data transfer rate according to the water level of the AFIFO buffer.

### CROSS REFERENCE TO RELATED APPLICATIONS

This application claims the benefit of U.S. provisional application No. 62/203,399, filed on Aug. 11, 2015 and incorporated herein by reference.

### BACKGROUND

The present invention relates to a network device design, and more particularly, to an asynchronous first-in first-out (AFIFO) buffer apparatus with active rate control and dynamic rate compensation and an associated network device using the same.

A multi-mode, multi-rate serial link application (e.g., an Ethernet switch device) has a set of dedicated asynchronous first-in first-out (AFIFO) buffers for each mode corresponding to a particular network line rate, where AFIFO buffers are located between a transport layer transmit/receive (TX/RX) circuit and a physical layer transmit/receive (TX/RX) circuit. As a result, the AFIFO buffer design of the multi-mode, multi-rate serial link application (e.g., Ethernet switch device) suffers from combo data paths, complex clock structure, large elastic buffers, routing issue, etc. Supposing that a network device has 12 lanes for transmitting network packet data and 12 lanes for receiving network packet data, and supports 5 modes (e.g., 1G, 10G, 40G, 50G and 100G), the clock structure may need to provide up to 120 (i.e., 12*2*5) clocks. Large elastic buffers (i.e., AFIFO buffers) may be needed for rate compensation between the link clock and the system clock, which resulting in high latency inevitably. In addition, it is hard to implement the chip physical routing for the combo data paths and the complex clock structure, and there may be various latency skew variations for different modes. However, latency and latency skew performance is critical to the Ethernet switch system, especially the time synchronous application using the IEEE 1588 precision time protocol (PTP).

### SUMMARY

One of the objectives of the claimed invention is to provide an asynchronous first-in first-out (AFIFO) buffer apparatus with active rate control and dynamic rate compensation and an associated network device using the same.

According to a first aspect of the present invention, an exemplary asynchronous first-in first-out (AFIFO) buffer apparatus is disclosed. The AFIFO buffer apparatus includes an AFIFO buffer and a rate control circuit. The AFIFO buffer is arranged to receive a data input from a first processing circuit operating under a first clock, and transmit a data output to a second processing circuit operating under a second clock, wherein the first clock is asynchronous to the second clock. The rate control circuit is arranged to actively control a data transfer rate of the data input regardless of a water level of the AFIFO buffer, and further arranged to adaptively apply compensation to the data transfer rate according to the water level of the AFIFO buffer.

According to a second aspect of the present invention, an exemplary asynchronous first-in first-out (AFIFO) buffer apparatus is disclosed. The exemplary AFIFO buffer apparatus includes an AFIFO buffer and a rate control circuit. The AFIFO buffer is arranged to receive a data input from a first processing circuit operating under a first clock, and transmit a data output to a second processing circuit operating under a second clock, wherein the first clock is asynchronous to the second clock. The rate control circuit is arranged to actively control a data transfer rate of the data output regardless of a water level of the AFIFO buffer, and further arranged to adaptively apply compensation to the data transfer rate according to the water level of the AFIFO buffer.

According to a third aspect of the present invention, an exemplary network device is disclosed. The exemplary network device includes a multi-mode physical layer transmit circuit, a physical medium attachment (PMA) transmit circuit, and an asynchronous first-in first-out (AFIFO) buffer apparatus. The multi-mode physical layer transmit circuit is arranged to support a plurality of different modes corresponding to different network line rates, respectively. The AFIFO buffer apparatus has at least one AFIFO buffer shared by the different modes, wherein the at least one AFIFO buffer is arranged to receive a data input from the multi-mode physical layer transmit circuit under a first clock, and transmit a data output to the PMA transmit circuit under a second clock, where the first clock is asynchronous to the second clock.

According to a fourth aspect of the present invention, an exemplary network device is disclosed. The exemplary network device includes a multi-mode physical layer receive circuit, a physical medium attachment (PMA) receive circuit, and an asynchronous first-in first-out (AFIFO) buffer apparatus. The multi-mode physical layer receive circuit is arranged to support a plurality of different modes corresponding to different network line rates, respectively. The AFIFO buffer apparatus has at least one AFIFO buffer shared by the different modes, wherein the at least one AFIFO buffer is arranged to receive a data input from the PMA receive circuit under a first clock, and transmit a data output to the multi-mode physical layer receive circuit under a second clock, where the first clock is asynchronous to the second clock.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a network device according to an embodiment of the present invention.

FIG. 2 is a diagram illustrating a partial rate-controlled transmit part of the network device according to an embodiment of the present invention.

FIG. 3 is a diagram illustrating an operation of the AFIFO buffer according to an embodiment of the present invention.

FIG. 4 is a diagram illustrating a data enable signal with no compensation applied thereto and a data enable signal with compensation applied thereto according to an embodiment of the present invention.

FIG. 5 is a diagram illustrating an AFIFO water level according to an embodiment of the present invention.

FIG. 6 is a diagram illustrating a partial rate-controlled receive part of the network device according to an embodiment of the present invention.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

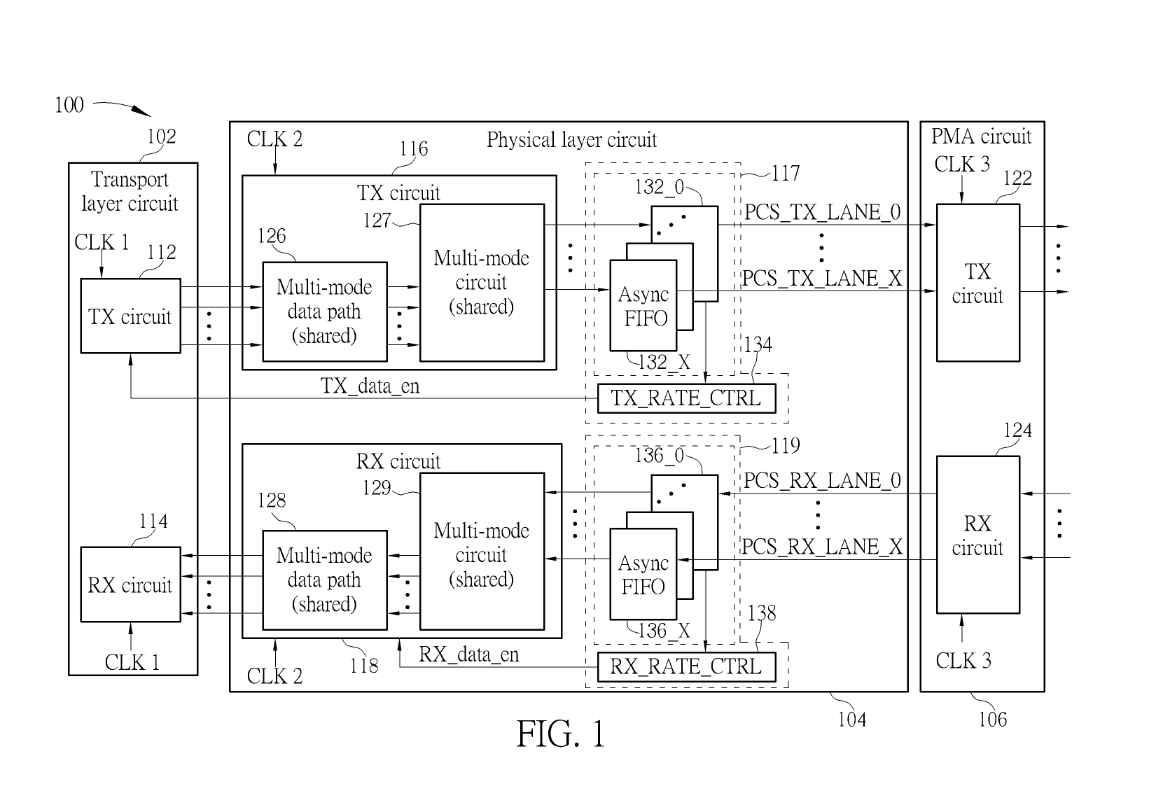

FIG. 1 is a diagram illustrating a network device according to an embodiment of the present invention. For example, the network device 100 may be an Ethernet switch. In this embodiment, the network device 100 includes a transport layer circuit 102, a physical layer circuit (e.g., a physical coding sublayer (PCS) circuit) 104, and a physical medium attachment (PMA) circuit 106. The transport layer circuit 102 includes a transmit (TX) circuit 112 and a receive (RX) circuit 114. The physical layer circuit 104 includes a TX circuit 116, an RX circuit 118, a TX asynchronous first-in first-out (AFIFO) apparatus 117, and an RX AFIFO apparatus 119. The PMA circuit 106 has a TX circuit 122 and an RX circuit 124. Since the present invention focuses on an innovative design of the physical layer circuit 104 and a person skilled in the art should readily understand operations and functions of the transport layer circuit 102 and the PMA circuit 106, further description of the transport layer circuit 102 and the PMA circuit 106 is omitted here for brevity.

With regard to the proposed physical layer circuit 104, the TX circuit 116 is a multi-mode physical layer TX circuit that is capable of supporting a plurality of different modes corresponding to different network line rates (e.g., 1G mode, 10G mode, 40G mode, 50G mode, 100G mode, etc.), the RX circuit 118 is a multi-mode physical layer RX circuit that is capable of supporting a plurality of different modes corresponding to different network line rates (e.g., 1G mode, 10G mode, 40G mode, 50G mode, 100G mode, etc.), the TX AFIFO buffer apparatus 117 is located between the TX circuit 116 of the physical layer circuit 104 and the PMA TX circuit (i.e. TX circuit 122 of the PMA circuit 106), and the RX AFIFO buffer apparatus 119 is located between RX circuit 118 of physical layer circuit 104 and PMA RX circuit (i.e. RX circuit 124 of PMA circuit 106). In this embodiment, the TX circuit 116 includes a multi-mode data path 126 and a multi-mode circuit 127, the RX circuit 116 includes a multi-mode data path 128 and a multi-mode circuit 129, the TX AFIFO buffer apparatus 117 includes a plurality of AFIFO buffers (also denoted as “Async FIFO”) 132_0-132_X and a rate control circuit (also denoted as “TX_RATE_CTRL”) 134, and the RX AFIFO buffer apparatus 119 includes a plurality of AFIFO buffers (also denoted as “Async FIFO”) 136_0-136_X and a rate control circuit (also denoted as “RX_RATE_CTRL”) 138.

The multi-mode circuit 127 is shared by different modes and thus can be configured to operate in any of the supported modes. Since the multi-mode circuit 127 can be configured to operate in one of the supported modes, the multi-mode data path 126 can be shared to transmit data inputs of any selected mode from the TX circuit 112 of the transport layer circuit 102 to the multi-mode circuit 127. Similarly, the multi-mode circuit 129 is shared by different modes and thus can be configured to operate in one of the supported modes. Since the multi-mode circuit 129 can be configured to operate in one of the supported modes, the multi-mode data path 128 can be shared to transmit data outputs of any selected mode from the multi-mode circuit 129 to the RX circuit 114 of the transport layer circuit 102. In this way, the combo data path issue and/or the routing issue encountered by the conventional network device can be avoided in the proposed network device 100.

The TX AFIFO buffer apparatus 117 is shared by the TX circuit 116 for receiving data inputs generated from the TX circuit 116 that can be configured to operate in different modes. Therefore, at least one of the AFIFO buffers 132_0-132_X is shared/reused by different modes supported by the TX circuit 116. Similarly, the RX AFIFO buffer apparatus 119 is shared by the RX circuit 118 for transmitting data outputs to the RX circuit 118 that can be configured to operate in different modes. Therefore, at least one of the AFIFO buffers 136_0-136_X is shared/reused by different modes supported by the RX circuit 118. Since the TX AFIFO buffer apparatus 117 is shared by the TX circuit 116 (which is a multi-mode TX circuit) and the RX AFIFO buffer apparatus 119 is shared by the RX circuit 118 (which is a multi-mode RX circuit), the complex clock structure issue encountered by the conventional network device can be avoided in the proposed network device 100.

Further, since the TX AFIFO buffer apparatus 117 is shared by the TX circuit 116 (which is a multi-mode TX circuit) and the RX AFIFO buffer apparatus 119 is shared by the RX circuit 118 (which is a multi-mode RX circuit), the large elastic buffer size issue can also be avoided in the proposed network device 100. For example, suppose that a multi-rate, multi-mode network device is configured to support a 1G mode (e.g., SGMII interface with A lanes), a 10G mode (e.g., XFI interface with B lanes) and a 40G mode (e.g., XLAUI interface with C lanes). The conventional network device design requires (A+B+C) AFIFO buffers, where A dedicated AFIFO buffers are implemented to serve as elastic buffers for the 1G mode, B dedicated AFIFO buffers are implemented to serve as elastic buffers for the 10G mode, and C dedicated AFIFO buffers are implemented to serve as elastic buffers for the 40G mode. However, the proposed network device design only uses C shared AFIFO buffers, if C>B>A. Hence, when the 1G mode is selected, A AFIFO buffers selected from the C shared AFIFO buffers are used to serve as elastic buffers; when the 10G mode is selected, B AFIFO buffers selected from the C shared AFIFO buffers are used to serve as elastic buffers; and when the 40G mode is selected, all of the C shared AFIFO buffers are used to serve as elastic buffers.

In this embodiment, when one of the supported mode is selected, the TX circuit 112 of the transport layer circuit 102 and the TX circuit 116 of the physical layer circuit 104 operate in a first clock domain for the selected mode, such that the clock CLK1 of the TX circuit 112 under the selected mode is synchronous to the clock CLK2 of the TX circuit 116 under the selected mode; and the RX circuit 114 of the transport layer circuit 102 and the RX circuit 118 of the physical layer circuit 104 operate in the first clock domain, such that the clock CLK1 of the RX circuit 114 under the selected mode is synchronous to the clock CLK2 of the RX circuit 128 under the selected mode. However, the PMA circuit 106 operates in a second clock domain, such that the clock CLK3 of the TX circuit 122 under the selected mode is asynchronous to the clock CLK2 of the TX circuit 116 under the selected mode, and the clock CLK3 of the RX circuit 124 under the selected mode is asynchronous to the clock CLK2 of the RX circuit 118 under the selected mode. Hence, each of the AFIFO buffers 132_0-132_X is arranged to receive a data input from one processing circuit operating under one clock (e.g., TX circuit 116 operating under the clock CLK2), and transmit a data output to a different processing circuit operating under a different clock (e.g., TX circuit 122 operating under the clock CLK3). In addition, each of the AFIFO buffers 136_0-136_X is arranged to receive a data input from one processing circuit operating under one clock (e.g., RX circuit 124 operating under the clock CLK3), and transmit a data output to a different processing circuit operating under a different clock (e.g., RX circuit 118 operating under the clock CLK2).

The AFIFO buffers 132_0-132_X are located at a plurality of lanes PCS_TX_LANE_0-PCS_TX_LANE_X, respectively, and are used for rate compensation between the physical layer (PHY) clock CLK2 and the PMA clock CLK3. Similarly, the AFIFO buffers 136_0-136_X are located at a plurality of lanes PCS_RX_LANE_0-PCS_RX_LANE_X, respectively, and are used for rate compensation between the PMA clock CLK3 and the PHY clock CLK2. In this embodiment, the rate control circuit 134 is arranged to control a data transfer rate of a data input received by each of the AFIFO buffers 132_0-132_X to thereby maintain a water level of each of the AFIFO buffers 132_0-132_X around a predetermined level (e.g., half of the AFIFO buffer depth), and the rate control circuit 138 is arranged to control a data transfer rate of a data output transmitted from each of the AFIFO buffers 136_0-136_X to thereby maintain a water level of each of the AFIFO buffers 136_0-136_X around a predetermined level (e.g., half of the AFIFO buffer depth). Since the rate control mechanism is capable of maintaining a water level of an AFIFO buffer around a predetermined level, the AFIFO buffer is allowed to have a shorter buffer depth (i.e., smaller buffer size) without buffer underflow/overflow. Hence, the high latency issue and/or high latency variation issue encountered by the conventional network device can be avoided in the proposed network device 100.

In this embodiment, the rate control circuit 134 is capable of making the data enable signal TX_data_en have an almost average distribution of enable pulses, and the rate control circuit 138 is capable of making the data enable signal RX_data_en have an almost average distribution of enable pulses. For example, the rate control circuit 134 refers to bit patterns to actively configure the data enable signal TX_data_en, and the rate control circuit 138 refers to bit patterns to actively configure the data enable signal RX_data_en. In this way, the behavior of the data enable signal TX_data_en/RX_data_en is almost fixed. Hence, the data enable variation issue encountered by the conventional network device can be avoided in the proposed network device 100. IEEE standard 1588 defines a protocol, enabling precise synchronization of clocks in measurement and control systems, implemented with technologies such as network communication, local computing, and distributed objects. The synchronization is achieved by exchanging PTP timing messages, with the slaves using the timing information to adjust their clocks to the time of GMC (grand master clock). Since each of the data enable signals TX_data_en and RX_data_en has an almost average distribution of enable pulses (i.e., an almost fixed signal pattern with very small variation), the data enable signals TX_data_en and RX_data_en are suitable for an IEEE 1588 PTP application.

Further details of rate control mechanisms employed by TX AFIFO buffer apparatus 117 and RX AFIFO buffer apparatus 119 are described as below.

When the TX circuit 116 is configured to operate in a first mode corresponding to a first network line rate (e.g., 10G mode), a single lane PCS_TX_LANE_0 may be used to transmit a data input from the multi-mode circuit 127 to the AFIFO buffer 132_0. When the TX circuit 116 is configured to operate in a second mode corresponding to a second network line rate (e.g., 40G mode), multiple lanes (which include lane PCS_TX_LANE_0) may be used to transmit multiple data inputs from the multi-mode circuit 127 to multiple AFIFO buffers (which include AFIFO buffer 132_0) in a parallel manner, where the multiple AFIFO buffers may have the same or similar behavior, i.e., the water levels of the multiple AFIFO buffers maybe same or similar. In a case where a single lane PCS_TX_LANE_0 may be used under a selected mode, the data enable signal TX_data_en set by the rate control circuit 134 controls the data transfer rate of the data input fed into the AFIFO buffer 132_0. In another case where multiple lanes (which include lane PCS_TX_LANE_0) are used under another selected mode, the data enable signal TX_data_en set by the rate control circuit 134 controls data transfer rates of multiple data inputs fed into multiple AFIFO buffers (which include the AFIFO buffer 132_0).

In this embodiment, the rate control circuit 134 is arranged to monitor the water level of the AFIFO buffer 130_0 shared by all modes supported by the TX circuit 116 to adaptively adjust the data enable signal TX_data_en for dynamic data transfer rate compensation. Further, the rate control circuit 134 is arranged to actively set the data enable signal TX_data_en for active data transfer rate control regardless of the water level of the AFIFO buffer 132_0. Hence, the data enable signal TX_data_en has an almost fixed signal pattern during each predetermined time period due to the active data transfer rate control, and a signal pattern generated during the next predetermined time period may be different from a signal pattern generated during the current predetermined time period due to the dynamic data transfer rate compensation.

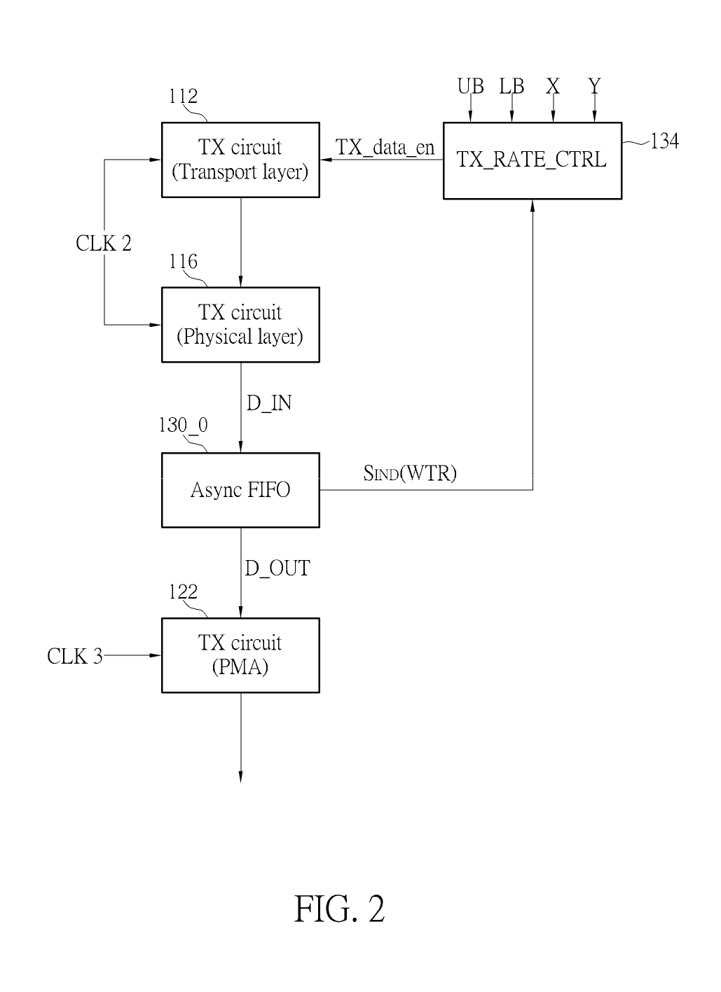

Please refer to FIG. 2, which is a diagram illustrating a partial rate-controlled TX part of the network device 100 according to an embodiment of the present invention. In this embodiment, the AFIFO buffer (also denoted as “Async FIFO) 132_0 is arranged to receive a data input D_IN from the TX circuit 116 operating under a physical layer (PHY) clock CLK2, and transmit a data output D_OUT to the TX circuit 122 operating under the PMA clock CLK3, where the PHY clock CLK2 is asynchronous to the PMA clock CLK3. The rate control circuit 134 is programmed by a software module to store a plurality of different bit patterns (e.g., X and Y), and reads the different bit patterns (e.g., X and Y) to set a data enable signal TX_data_en generated for actively controlling the data transfer rate of the data input D_IN regardless of the water level of the AFIFO buffer 130_0. The data enable signal TX_data_en controls the data transfer between the TX circuit 112 of the transport layer circuit 102 and the TX circuit 116 of the physical layer circuit 104, and accordingly controls the data transfer between the TX circuit 116 and the AFIFO buffer 130_0 of the physical layer circuit 104.

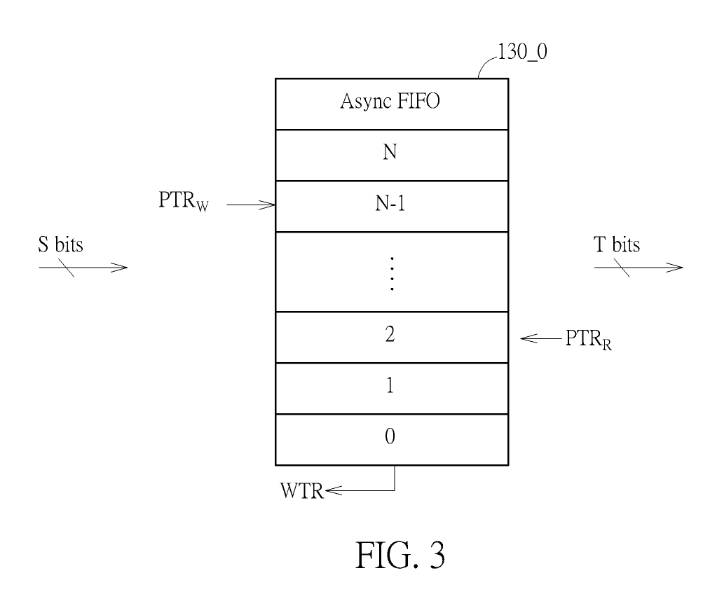

The default settings of the bit patterns X and Y can be configured based on the clock rate of the PHY clock CLK2, the clock rate of the PMA clock CLK3, the number of bits transmitted per clock cycle of the PHY clock CLK2, and the number of bits transmitted per clock cycle of the PMA clock CLK3. Please refer to FIG. 3, which is a diagram illustrating an operation of the AFIFO buffer 130_0 according to an embodiment of the present invention. A read pointer PTR_{R} points to a read address of the AFIFO buffer 130_0, and a write pointer PTR_{W} points to a write address of the AFIFO buffer 130_0. For example, the AFIFO buffer 130_0 may be divided into a plurality of storage units (e.g., data words). The write pointer PTR_{W} will point to a start address of a next storage unit when a current storage unit is filled with data bits written therein, and the read pointer PTR_{R} will point to a start address of a next storage unit when all data bits stored in a current storage unit are read. In this embodiment, S bits can be transmitted from the TX circuit 116 to the AFIFO buffer 130_0 in one clock cycle of the PHY clock CLK2, and T bits can be transmitted from the AFIFO buffer 130_0 to the TX circuit 122 in one clock cycle of the PMA clock CLK3.

If the data transmission from the TX circuit 116 to the AFIFO buffer 130_0 is enabled for each clock cycle of the PHY clock CLK2 and the data transmission from the AFIFO buffer 130_0 to the TX circuit 122 is enabled for each clock cycle of the PMA clock CLK3, the data transfer rate of the data input D_IN of the AFIFO buffer 130_0 is FREQ2*S bps (bits per second), and the data transfer rate of the data output D_OUT of the AFIFO buffer 130_0 is FREQ3*T bps (bits per second), where FREQ2 is the clock rate of the PHY clock CLK2, and FREQ3 is the clock rate of the PMA clock CLK3. Taking a 10G mode for example, FREQ2 is 0.515 GHz, FREQ3 is 0.5 GHz, S is 20, and T is 66. Hence, the data transfer rate of the data input D_IN of the AFIFO buffer 130_0 and the data transfer rate of the data output D_OUT of the AFIFO buffer 130_0 have the following relation.

$$\frac{FREQ 2 * S}{FREQ 3 * T} = \frac{0.515 GHz * 20 bits}{0.5 GHz * 66 bits} = 0.3125 = 0.3 * A ( T ) + 0.4 * B ( T ) \qquad ( 1 )$$

As can be known from above equation (1), the data transfer rate of the data input D_IN of the AFIFO buffer 130_0 is higher than the data transfer rate of the data output D_OUT of the AFIFO buffer 130_0 if the data transmission from the TX circuit 116 to the AFIFO buffer 130_0 is enabled for each clock cycle of the PHY clock CLK2 and the data transmission from the AFIFO buffer 130_0 to the TX circuit 122 is enabled for each clock cycle of the PMA clock CLK3. As a result, the AFIFO buffer 130_0 will suffer from buffer overflow. The rate control circuit 134 is arranged to control the data transfer rate of the data input D_IN of the AFIFO buffer 130_0 by properly setting the data enable signal TX_data_en. Hence, the data transmission from the TX circuit 116 to the AFIFO buffer 130_0 is not enabled for each clock cycle of the PHY clock CLK2 under the control of the data enable signal TX_data_en. In one embodiment, the rate control circuit 134 controls the data enable signal TX_data_en to ensure that the data transfer rate of the data input D_IN of the AFIFO buffer 130_0 is substantially equal to the data transfer rate of the data output D_OUT of the AFIFO buffer 130_0 under the condition that the data transmission from the AFIFO buffer 130_0 to the TX circuit 122 is enabled for each clock cycle of the PMA clock CLK3. Preferably, the data enable signal TX_data_en is properly set to make the AFIFO buffer 130_0 have a long-term filtered medium water level (e.g., only half of the AFIFO buffer 130_0 is filled with valid data at an end of each predetermined time period). The value 0.3 (i.e., 3/10) in above equation (1) can be used to configure the bit pattern X, the value 0.4 (i.e., ⅖) in above equation (1) can be used to configure the bit pattern Y, the value A (T) in above equation (1) can be used to configure the number of times of repeating the bit pattern X during one predetermined time period, and the value B (T) in above equation (1) can be used to configure the number of times of repeating the bit pattern Y during one predetermined time period.

The data transmission is enabled when the data enable signal TX_data_en has a first logic level (e.g., a logic high level), and the data transmission is disabled when the data enable signal TX_data_en has a second logic level (e.g., a logic low level). The rate control circuit 134 reads each of the different bit patterns (e.g., X and Y) at least once during one predetermined time period to set the data enable signal TX_data_en according to binary values recorded in each bit pattern, where the data enable signal TX_data_en is set to have the first logic level in one clock cycle when one bit of the bit pattern has a first binary value, and the data enable signal TX_data_en is set to have the second logic level in one clock cycle when one bit of the bit pattern has a second binary value. In a case where the first binary value is “1” and the second binary value is “0”, the bit pattern X may be a 10-bit pattern programmed to have three 1's and seven 0's due to the value 0.3 (i.e., 3/10) in above equation (1), and the bit pattern Y may be a 5-bit pattern programmed to have two 1's and three 0's due to the value 0.4 (i.e., ⅖) in above equation (1). In one embodiment, each of the bit patterns X and Y does not have consecutive bits each having the first binary values. In this way, a data transmission bust can be avoided to reduce the overflow probability of the AFIFO buffer 130_0.

In another case where the first binary value is “0” and the second binary value is “1”, the bit pattern X may be a 10-bit pattern programmed to have three 0's and seven 1's due to the value 0.3 (i.e., 3/10) in above equation (1), and the bit pattern Y may be a 5-bit pattern programmed to have two 0's and three 1's due to the value 0.4 (i.e., ⅖) in above equation (1). In one embodiment, each of the bit patterns X and Y does not have consecutive bits each having the first binary values. In this way, a data transmission bust can be avoided to reduce the overflow probability of the AFIFO buffer 130_0.

As mentioned above, the value A(T) in above equation (1) can be used to configure the number of times of repeating the bit pattern X during one predetermined time period, and the value B(T) in above equation (1) can be used to configure the number of times of repeating the bit pattern Y during one predetermined time period. For example, the value A (T) may be set by 0.875 (i.e., ⅞), and the value B(T) may be set by 0.125 (i.e., ⅛). Hence, one predetermined time period may correspond to 80 clock cycles of the PHY clock CLK2. During one predetermined time period, the rate control circuit 134 reads the bit pattern X (which is set by a 10-bit pattern) seven times and reads the bit pattern Y (which is set by a 5-bit pattern) twice. Hence, during one predetermined time period corresponding to 80 clock cycles of the PHY clock CLK2, the data transmission is enabled for 25 (i.e., 3*7+2*2) clock cycles only. Hence, the number of bits transmitted from the TX circuit 116 to the AFIFO buffer 130_0 during one predetermined time period is equal to 1650 (i.e., 25*66) for the 10G mode. Since the clock rate of the PMA clock CLK3 is 0.515 GHz, the PMA clock CLK3 has 82.5 clock cycles during the one predetermined time period (i.e., 80 clock cycles of the PHY clock CLK2). Hence, the number of bits transmitted from the AFIFO buffer 130_0 to the TX circuit 122 during one predetermined time period is also equal to 1650 (i.e., 82.5*20) for the 10G mode.

Ideally, at the end of each predetermined time period (i.e., 80 clock cycles of the PHY clock CLK2), the long-term filtered water level of the AFIFO buffer 130_0 remains unchanged due to the fact that the number of bits transmitted from the TX circuit 116 to the AFIFO buffer 130_0 during a predetermined time period is equal to the number of bits transmitted from the AFIFO buffer 130_0 to the TX circuit 122 during the same predetermined time period.

Due to certain factors such as FIFO metastability, some bits transmitted from the TX circuit 116 may not be successfully stored in the AFIFO buffer 130_0 during one predetermined time period, and/or some bits in the AFIFO buffer 130_0 may be successfully retrieved by the TX circuit 122 during one predetermined time period. To ensure that the AFIFO buffer 130_0 is maintained around a target water level such as a medium water level, the rate control circuit 134 is further arranged to adaptively apply compensation to the data transfer rate of the data input of the AFIFO buffer 130_0 according to the water level of the AFIFO buffer 130_0 checked at the end of each predetermined time period. In one embodiment, the AFIFO buffer 130_0 provides an indication signal S_{IND} to the rate control circuit 134 at an end of each predetermined time period, where the indication signal S_{IND} is indicative of a water level WTR of the AFIFO buffer 130_0. Hence, the rate control circuit 134 checks the water level WTR of the AFIFO buffer 130_0 at an end of a current predetermined time period, and refers to the water level WTR of the AFIFO buffer 130_0 to adaptively apply the compensation to the data enable signal TX_data_en generated during a next predetermined time period.

For example, the rate control circuit 134 is further programmed to store an upper bound UP and a lower bound LB of a predetermined water level range. At an end of the current predetermined time period, the rate control circuit 134 compares the water level WTR of the AFIFO buffer 130_0 with the upper bound UP and the lower bound LB. If the water level WTR of the AFIFO buffer 130_0 falls within the predetermined water level range delimited by the upper bound UP and the lower bound LB, no compensation is applied to the data enable signal TX_data_en, and the default bit patterns (i.e., initially programmed bit patterns X and Y) will be used for setting the data enable signal TX_data_en generated during the next time period. If the water level WTR of the AFIFO buffer 130_0 is found beyond the predetermined water level range delimited by the upper bound UP and the lower bound LB, the rate control circuit 134 applies compensation to the data enable signal TX_data_en by adjusting at least one of the bit patterns X and Y, where the at least one adjusted bit patter and at least a portion (i.e., part or all) of the default bit patterns (i.e., initially programmed bit patterns X and Y) will be used for setting the data enable signal TX_data_en generated during the next predetermined time period.

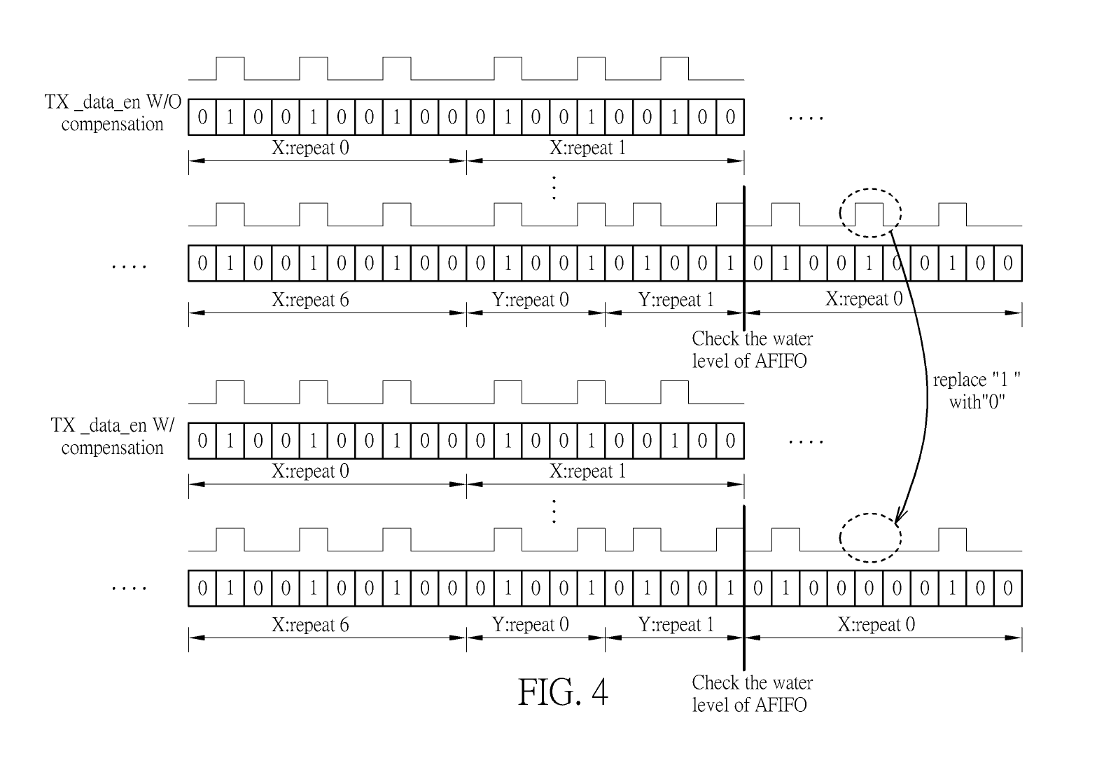

FIG. 4 is a diagram illustrating a data enable signal TX_data_en with no compensation applied thereto and a data enable signal TX_data_en with compensation applied thereto according to an embodiment of the present invention. For clarity and simplicity, it is assumed that the data enable signal TX_data_en is set to have the logic high level in one clock cycle when one bit of a bit pattern has a binary value “1”, and the data enable signal TX_data_en is set to have the logic low level in one clock cycle when one bit of a bit pattern has a binary value “0”. In this embodiment, the bit pattern X is programmed to be a 10-bit pattern “0100100100”, and the bit pattern Y is programmed to be a 5-bit pattern “01001”. During a current predetermined time period (i.e., 80 clock cycles of the PHY clock CLK2), the rate control circuit 134 reads the bit pattern X seven times and then reads the bit pattern Y two times, and sets the data enable signal TX_data_en based on bits recorded in the bit patterns X and Y. At the end of the current predetermined time period, the rate control circuit 134 checks the water level WTR of the AFIFO buffer 130_0 to determine whether to apply compensation to the data transfer rate of the data input D_IN of the AFIFO buffer 130_0. In a case where the water level WTR of the AFIFO buffer 130_0 falls within the predetermined water level range (i.e., LB≦WTR≦UB), no compensation is applied to the data transfer rate of the data input D_IN of the AFIFO buffer 130_0 during the next predetermined time period. In another case where the water level WTR of the AFIFO buffer 130_0 is beyond the predetermined water level range (i.e., WTR<LB or WTR>UB), the rate control circuit 134 adjusts at least one bit pattern (e.g., bit pattern X) to convert one or more 1's into 0's if the water level WTR of the AFIFO buffer 130_0 exceeds the upper bound UB, and adjusts at least one bit pattern (e.g., bit pattern X) to convert one or more 0's into 1's if the water level WTR of the AFIFO buffer 130_0 is below the lower bound LB.

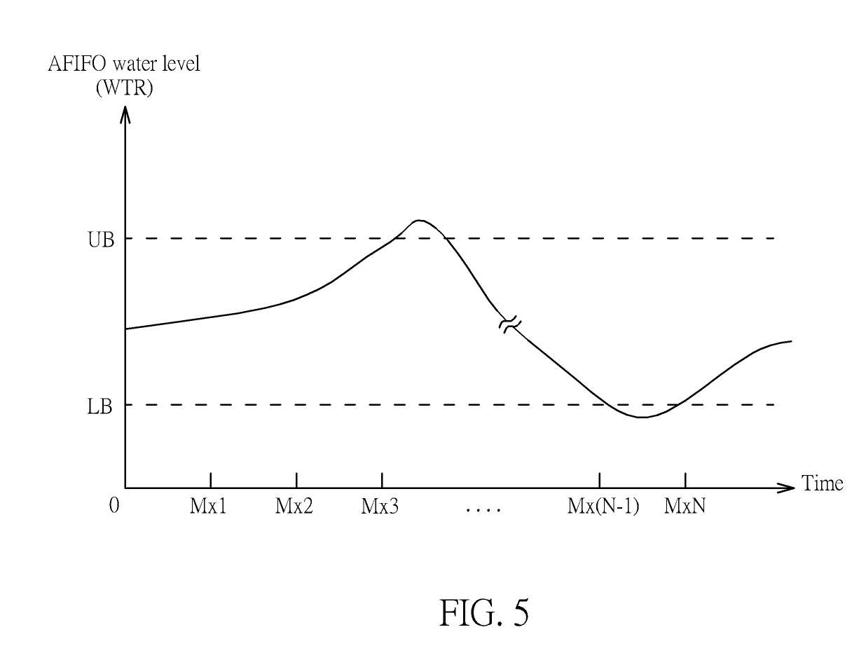

FIG. 5 is a diagram illustrating adjustment of an AFIFO water level according to an embodiment of the present invention. M is a unit of time to check the water level WTR of the AFIFO buffer 130_0. For example, M is the aforementioned predetermined time period that is defined by 80 clock cycles of the PHY clock CLK2. As shown in FIG. 5, when the water level WTR of the AFIFO buffer 130_0 is found higher than the upper bound UB at an end of one predetermined time period, the rate control circuit 134 adjusts the data enable signal TX_data_en to reduce the data transfer rate of the data input D_IN of the AFIFO buffer 130_0 during the next predetermined time period, thereby lowering the water level WTR of the AFIFO buffer 130_0. When the water level WTR of the AFIFO buffer 130_0 is found lower than the lower bound LB at an end of one predetermined time period, the rate control circuit 134 adjusts the data enable signal TX_data_en to increase the data transfer rate of the data input D_IN of the AFIFO buffer 130_0 during the next predetermined time period, thereby raising the water level WTR of the AFIFO buffer 130_0. The data transfer rate of the data input D_IN of the AFIFO buffer 130_0 is almost free running. A long-term check of the water level WTR of the AFIFO buffer 130_0 is periodically performed by the rate control circuit 134 to determine whether to enable the dynamic compensation for the free-running data transfer rate of the data input D_IN of the AFIFO buffer 130_0.

As mentioned above, the AFIFO buffer 130_0 provides an indication signal S_{IND} to inform the rate control circuit 134 of a water level WTR of the AFIFO buffer 130_0. In one exemplary design, the water level WTR of the AFIFO buffer 130_0 may be estimated based on a number of valid bits stored in the AFIFO buffer 130_0. Hence, a bit-level FIFO control can be employed by the rate control circuit 134 to control the water level of the AFIFO buffer 130_0. In another exemplary design, the water level WTR of the AFIFO buffer 130_0 may be estimated based on a distance between a read pointer PTR_{R} and a write pointer PTR_{W} of the AFIFO buffer 130_0. Hence, a pointer-level FIFO control can be employed by the rate control circuit 134 to control the water level of the AFIFO buffer 130_0. Compared to the pointer-level FIFO control, the bit-level FIFO control can more precisely control the water level of the AFIFO buffer 130_0, thus allowing the AFIFO buffer 130_0 to have smaller size and lower latency. However, this is for illustrative purposes only, and is not meant to be a limitation of the present invention.

The same invention concept applied to the TX part of the network device 100 may also be applied to the RX part of the network device 100. When the RX circuit 118 is configured to operate in a first mode corresponding to a first network line rate (e.g., 10G mode), a single lane PCS_RX_LANE_0 may be used to transmit a data output from the AFIFO buffer 136_0 to the multi-mode circuit 129. When the RX circuit 118 is configured to operate in a second mode corresponding to a second network line rate (e.g., 40G mode), multiple lanes (which include lane PCS_RX_LANE_0) may be used to transmit multiple data outputs from multiple AFIFO buffers (which include AFIFO buffer 136_0) to the multi-mode circuit 129 in a parallel manner, where the multiple AFIFO buffers may have the same or similar behavior, i.e., the water levels of the multiple AFIFO buffers may be same or similar. In a case where a single lane PCS_RX_LANE_0 may be used under a selected mode, the data enable signal RX_data_en controls the data transfer rate of the data output transmitted from the AFIFO buffer 136_0. In another case where multiple lanes (which include lane PCS_RX_LANE_0) may be used under another selected mode, the data enable signal RX_data_en controls data transfer rates of multiple data outputs transmitted from multiple AFIFO buffers (which include AFIFO buffer 136_0).

In this embodiment, the rate control circuit 138 is arranged to monitor the water level of the AFIFO buffer 136_0 shared by all modes supported by the RX circuit 118 to adaptively adjust the data enable signal RX_data_en for dynamic data transfer rate compensation. Further, the rate control circuit 138 is arranged to actively set the data enable signal RX_data_en for active data transfer rate control regardless of the water level of the AFIFO buffer 136_0. Hence, the data enable signal RX_data_en has an almost fixed signal pattern during each predetermined time period due to the active data transfer rate control, and a signal pattern generated during the next predetermined time period may be different from a signal pattern generated during the current predetermined time period due to the dynamic data transfer rate compensation.

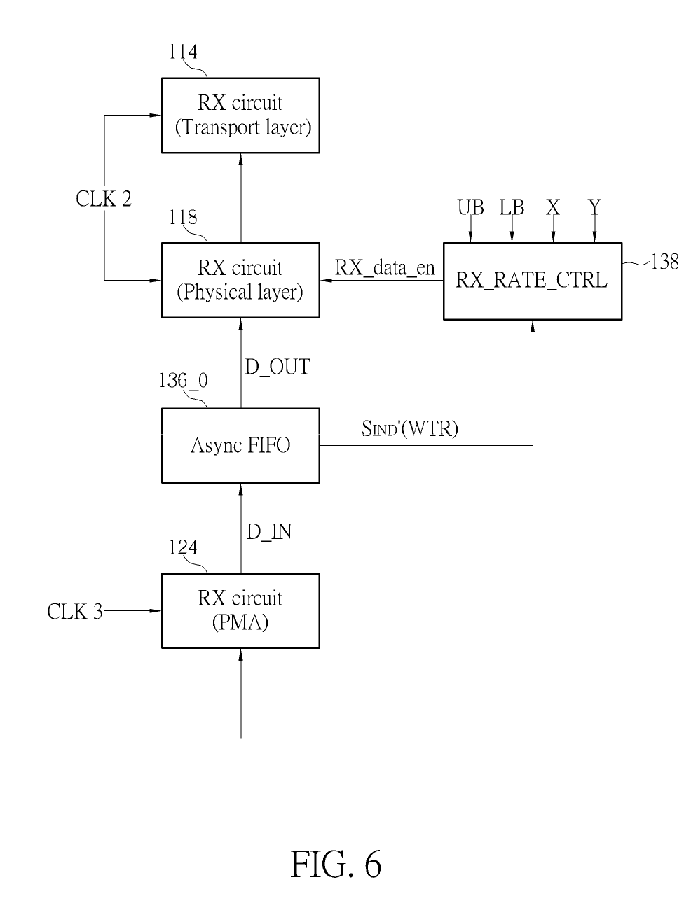

Please refer to FIG. 6, which is a diagram illustrating a partial rate-controlled RX part of the network device 100 according to an embodiment of the present invention. In this embodiment, the

AFIFO buffer (also denoted as “Async FIFO) 136_0 is arranged to receive a data input D_IN from the RX circuit 124 operating under the PMA clock CLK3, and transmit a data output D_OUT to the RX circuit 118 operating under the PHY clock CLK2, where the PHY clock CLK2 is asynchronous to the PMA clock CLK3. Like the rate control circuit 134 shown in FIG. 2, the rate control circuit 138 is programmed by a software module to store a plurality of different bit patterns (e.g., X and Y) and a plurality of water level threshold values (e.g., upper bound UB and lower bound LB), and reads the different bit patterns (e.g., X and Y) to set a data enable signal RX_data_en generated for actively controlling the data transfer rate of the data output D_OUT regardless of the water level of the AFIFO buffer 136_0.

Moreover, due to certain factors such as FIFO metastability, some bits transmitted from the RX circuit 124 may not be successfully stored in the AFIFO buffer 136_0 during one predetermined time period, and/or some bits in the AFIFO buffer 136_0 may be successfully retrieved by the RX circuit 118 during one predetermined time period. To ensure that the AFIFO buffer 136_0 is maintained around a target water level such as a medium water level, the rate control circuit 138 is further arranged to adaptively apply compensation to the data transfer rate of the data output D_OUT of the AFIFO buffer 136_0 according to the water level of the AFIFO buffer 136_0. In one embodiment, the AFIFO buffer 136_0 provides an indication signal S_{IND}′ to the rate control circuit 138 at an end of each predetermined time period, where the indication signal S_{IND}′ is indicative of a water level WTR of the AFIFO buffer 136_0. Hence, the rate control circuit 138 checks the water level WTR of the AFIFO buffer 136_0 at an end of a current predetermined time period, and refers to the water level WTR of the AFIFO buffer 136_0 to adaptively apply the compensation to the data enable signal RX_data_en generated during a next predetermined time period.

For example, at an end of the current predetermined time period, the rate control circuit 138 compares the water level WTR of the AFIFO buffer 136_0 with the upper bound UP and the lower bound LB. If the water level WTR of the AFIFO buffer 136_0 falls within the predetermined water level range delimited by the upper bound UP and the lower bound LB, no compensation is applied to the data enable signal RX_data_en, and the default bit patterns (i.e., initially programmed bit patterns X and Y) will be used for setting the data enable signal RX_data_en generated during the next predetermined time period. If the water level WTR of the AFIFO buffer 136_0 is beyond the predetermined water level range delimited by the upper bound UP and the lower bound LB, the rate control circuit 138 applies compensation to the data enable signal RX_data_en by adjusting at least one of the bit patterns X and Y, and the at least one adjusted bit pattern and at least a portion (i.e., part or all) of the default bit patterns (i.e., initially programmed bit patterns X and Y) will be used for setting the data enable signal RX_data_en generated during the next predetermined time period.

The algorithms employed by the rate control circuit 138 to actively control and adaptively compensate the data enable signal RX_data_en may be the same as the algorithms employed by the rate control circuit 134 to actively control and adaptively compensate the data enable signal TX_data_en. For example, the data enable signal RX_data_en may be generated according to the same manner employed for setting the data enable signal TX_data_en shown in FIG. 4. Hence, a default bit pattern X initially programmed by a 10-bit pattern “0100100100” and a default bit pattern Y initially programmed by a 5-bit pattern “01001” are read by the rate control circuit 138, and an adjusted bit pattern may be generated by adjusting the default bit pattern X for rate compensation.

In addition, assuming that data transmission is enabled when the data enable signal RX_data_en has a first logic level and is disabled when the data enable signal RX_data_en has a second logic level, and the data enable signal RX_data_en is set to have the first logic level in one clock cycle when one bit of a bit pattern has a first binary value and is set to have the second logic level in one clock cycle when one bit of a bit pattern has a second binary value, each of the bit patterns X and Y does not have consecutive bits each having the first binary values. In this way, a data transmission bust can be avoided to reduce the underflow probability of the AFIFO buffer 136_0. Since a person skilled in the art can readily understand details of the rate control circuit 138 after reading above paragraphs directed to the rate control circuit 134, further description of the active rate control and the dynamic rate compensation is omitted here for brevity.

As mentioned above, the AFIFO buffer 136_0 provides an indication signal S_{IND} to inform the rate control circuit 138 of a water level WTR of the AFIFO buffer 136_0. In one exemplary design, the water level WTR of the AFIFO buffer 136_0 may be estimated based on the number of valid bits stored in the AFIFO buffer 136_0. Hence, a bit-level FIFO control can be employed by the rate control circuit 138 to control the water level of the AFIFO buffer 136_0. In another exemplary design, the water level WTR of the AFIFO buffer 136_0 may be estimated based on a distance between a read pointer and a write pointer of the AFIFO buffer 136_0. Hence, a pointer-level FIFO control can be employed by the rate control circuit 138 to control the water level of the AFIFO buffer 136_0. Compared to the pointer-level FIFO control, the bit-level FIFO control can more precisely control the water level of the AFIFO buffer 136_0, thus allowing the AFIFO buffer 136_0 to have smaller size and lower latency. However, this is for illustrative purposes only, and is not meant to be a limitation of the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An asynchronous first-in first-out (AFIFO) buffer apparatus comprising:
an AFIFO buffer, arranged to receive a data input from a first processing circuit operating under a first clock, and transmit a data output to a second processing circuit operating under a second clock, wherein the first clock is asynchronous to the second clock; and
a rate control circuit, arranged to actively control a data transfer rate of the data input regardless of a water level of the AFIFO buffer, and further arranged to adaptively apply compensation to the data transfer rate according to the water level of the AFIFO buffer.

2. The AFIFO buffer apparatus of claim 1, wherein the first processing circuit is a physical layer transmit circuit of a network device, and the second processing circuit is a physical medium attachment (PMA) transmit circuit of the network device.

3. The AFIFO buffer apparatus of claim 2, wherein the physical layer transmit circuit is a multi-mode transmit circuit; and the AFIFO buffer is shared by different modes supported by the multi-mode transmit circuit.

4. The AFIFO buffer apparatus of claim 1, wherein the rate control circuit is programmed to store a plurality of different bit patterns; and the rate control circuit reads the different bit patterns to set a data enable signal generated from the rate control circuit to control the data transfer rate of the data input.

5. The AFIFO buffer apparatus of claim 4, wherein data transmission is enabled when the data enable signal has a first logic level, and the data transmission is disabled when the data enable signal has a second logic level; the rate control circuit reads each of the different bit patterns at least once during one predetermined time period to set the data enable signal according to binary values recorded in the bit pattern, where the data enable signal is set to have the first logic level in one clock cycle when one bit of the bit pattern has a first binary value, and the data enable signal is set to have the second logic level in one clock cycle when one bit of the bit pattern has a second binary value.

6. The AFIFO buffer apparatus of claim 5, wherein each of the different bit patterns does not have consecutive bits each having the first binary value.

7. The AFIFO buffer apparatus of claim 4, wherein the rate control circuit is arranged to apply the compensation to the data transfer rate by adjusting at least one of the different bit patterns.

8. The AFIFO buffer apparatus of claim 1, wherein the rate control circuit checks the water level of the AFIFO buffer at an end of a current predetermined time period, and refers to the water level of the AFIFO buffer to adaptively apply the compensation to the data enable signal generated during a next predetermined time period.

9. The AFIFO buffer apparatus of claim 8, wherein data transmission is enabled when the data enable signal has a first logic level, and the data transmission is disabled when the data enable signal has a second logic level; and when the water level of the AFIFO buffer is beyond a predetermined water level range, the rate control circuit applies the compensation to the data enable signal by adjusting a number of times the data enable signal has the first logic level during the next predetermined time period.

10. An asynchronous first-in first-out (AFIFO) buffer apparatus comprising:
an AFIFO buffer, arranged to receive a data input from a first processing circuit operating under a first clock, and transmit a data output to a second processing circuit operating under a second clock, wherein the first clock is asynchronous to the second clock; and
a rate control circuit, arranged to actively control a data transfer rate of the data output regardless of a water level of the AFIFO buffer, and further arranged to adaptively apply compensation to the data transfer rate according to the water level of the AFIFO buffer.

11. The AFIFO buffer apparatus of claim 10, wherein the second processing circuit is a physical layer receive circuit of a network device, and the first processing circuit is a physical medium attachment (PMA) receive circuit of the network device.

12. The AFIFO buffer apparatus of claim 11, wherein the physical layer receive circuit is a multi-mode receive circuit; and the AFIFO buffer is shared by different modes supported by the multi-mode receive circuit.

13. The AFIFO buffer apparatus of claim 10, wherein the rate control circuit is programmed to store a plurality of different bit patterns;
and the rate control circuit reads the different bit patterns to set a data enable signal generated from the rate control circuit to control the data transfer rate of the data output.

14. The AFIFO buffer apparatus of claim 13, wherein data transmission is enabled when the data enable signal has a first logic level, and the data transmission is disabled when the data enable signal has a second logic level; the rate control circuit reads each of the different bit patterns at least once during one predetermined time period to set the data enable signal according to binary values recorded in the bit pattern, where the data enable signal is set to have the first logic level in one clock cycle when one bit of the bit pattern has a first binary value, and the data enable signal is set to have the second logic level in one clock cycle when one bit of the bit pattern has a second binary value.

15. The AFIFO buffer apparatus of claim 14, wherein each of the different bit patterns does not have consecutive bits each having the first binary value.

16. The AFIFO buffer apparatus of claim 13, wherein the rate control circuit is arranged to apply the compensation to the data transfer rate by adjusting at least one of the different bit patterns.

17. The AFIFO buffer apparatus of claim 10, wherein the rate control circuit checks the water level of the AFIFO buffer at an end of a current predetermined time period, and refers to the water level of the AFIFO buffer to adaptively apply the compensation to the data enable signal generated during a next predetermined time period.

18. The AFIFO buffer apparatus of claim. 17, wherein data transmission is enabled when the data enable signal has a first logic level, and the data transmission is disabled when the data enable signal has a second logic level; and when the water level of the AFIFO buffer is beyond a predetermined water level range, the rate control circuit applies the compensation to the data enable signal by adjusting a number of times the data enable signal has the first logic level during the next predetermined time period.

19. A network device comprising:
a multi-mode physical layer transmit circuit, arranged to support a plurality of different modes corresponding to different network line rates, respectively;
a physical medium attachment (PMA) transmit circuit; and
an asynchronous first-in first-out (AFIFO) buffer apparatus, comprising:
at least one AFIFO buffer, shared by the different modes, wherein the at least one AFIFO buffer is arranged to receive a data input from the multi-mode physical layer transmit circuit under a first clock, and transmit a data output to the PMA transmit circuit under a second clock, where the first clock is asynchronous to the second clock.

20. A network device comprising:
a multi-mode physical layer receive circuit, arranged to support a plurality of different modes corresponding to different network line rates, respectively;
a physical medium attachment (PMA) receive circuit; and
an asynchronous first-in first-out (AFIFO) buffer apparatus, comprising:
at least one AFIFO buffer, shared by the different modes, wherein the at least one AFIFO buffer is arranged to receive a data input from the PMA receive circuit under a first clock, and transmit a data output to the multi-mode physical layer receive circuit under a second clock, where the first clock is asynchronous to the second clock.
